(19) United States
(12) Patent Application Publication
(10) Pub. No.: US 2005/0280348 A1
(43) Pub. Date: Dec. 22, 2005

(54) Structure and method for fabricating multi-directional field-emission display and multi-directional electron emission source

(76) Inventors: Te-Fong Chan, Guanyin Township (TW); Chih-Che Kuo, Guanyin Township (TW); Yao-Zong Chen, Guanyin Township (TW); Frank Yang, Guanyin Township (TW); Chih-Hao Wu, Guanyin Township (TW); Kuei-Wen Cheng, Guanyin Township (TW)

Correspondence Address: Yi-Wen Tseng, 4331 Stevens Battle Lane, Fairfax, VA, 22033, US

(21) Appl. No.: 10/867,997

(22) Filed: Jun. 16, 2004

(51) Int. Cl. H01J 1/62; H01J 63/04

(52) U.S. Cl. 313/495

(57) ABSTRACT

A field emission display with multiple display directions includes an anode structure and a cathode structure. The anode structure has a plurality of peripheral sides, and each of the peripheral sides has an interior surface. A conductive layer and a phosphor layer formed on each interior surface of the shell substrate. The cathode structure is disposed within the shell substrate of the anode structure. The cathode structure has a plurality of peripheral sides facing respective interior surfaces of the anode structure and a conductive layer and an electron emission layer formed on each peripheral side of the cathode structure.

### BACKGROUND OF THE INVENTION

The present invention relates in general to structure and method for fabricating a multi-directional field-emission display and a multi-directional electron emission source, so as to provide a three-dimensional field-emission display operative to generate three-dimensional images.

The fast development of semiconductor technology allows many electric products to be fabricated light, thin, short and small. Some electric products are even portable or occupy minimum spaces in the house or a public space. For example, the flat panel displays such as liquid crystal displays (LCD), plasma display panel (PDP), organic light-emitting diode display (OLED) have successfully substitute the conventional heavy and bulky cathode ray tube display which uses electron emission source for generating images. However, the liquid crystal display, plasma display and organic light-emitting diode display are only able to display image on a single side.

To achieve two-side display by a single display, a dual-side display has been developed as shown in FIG. 1. The dual-side display has a cathode structure 3 and two anode structures 4 and 4′ at two sides of the cathode structure 3. The cathode structure 3 includes a substrate 31 that has two opposing surfaces. Electron emission layers 32 and 32′ are formed on the respective surfaces of the substrate 31. When a bias voltage 5 is applied across the cathode structure 3 and the anode structures 4 and 4′, electron beams are generated from the electron emission layers 32 and 32′ and impinge the anode structures 4 and 4′ to generate light, so as to produce the images.

The above dual-side display provides dual-side images. However, the electron beams generated by such type of dual-side display cannot produce multi-directional electron beams, such that three-dimensional images cannot be produced thereby.

### SUMMARY OF THE INVENTION

The present invention provides a field emission display having multiple display sides, including an anode structure and a cathode structure. The anode structure has a plurality of peripheral sides, and each of the peripheral sides has an interior surface. A conductive layer and a phosphor layer formed on each interior surface of the shell substrate. The cathode structure is disposed within the shell substrate of the anode structure. The cathode structure has a plurality of peripheral sides facing respective interior surfaces of the anode structure and a conductive layer and an electron emission layer formed on each peripheral side of the cathode structure. The shell substrate of the anode structure includes a transparent substrate, preferably a glass substrate. The number of the peripheral sides of the anode structure matches the number of the peripheral sides of the cathode structure. Preferably, the anode structure has a cross section conforming to that of the cathode structure. The cathode structure includes a glass substrate having configured with the peripheral sides. The electron emission layer is fabricated from carbon nanotube. The anode and cathode structures may be in the form of tetragonal prism or polygonal prism.

A method of fabricating a multi-directional field-emission display is also provided that comprises the following steps. A hollow shell transparent substrate having a plurality of interior side surfaces is provided. A conductive layer and a phosphor layer are on each of the interior side surfaces. A cathode substrate having a plurality side surfaces is provided. A conductive layer and an electron-emission layer are formed on each of the side surfaces. The cathode substrate is disposed in the transparent substrate, and each side surface of the cathode substrate with a perspective interior side surface is aligned with the respective interior surface of the transparent substrate.

The method step of forming the conductive layer on the transparent substrate includes spray sputtering, coating or evaporation, for example. The conductive layer of the transparent substrate is fabricated from silver paste. The electron emission layer is fabricated from carbon nanotube material. The method further comprises a step of vacuum packing the anode structure and the cathode structure.

A multi-directional field-emission display is provided with an anode structure having a plurality of anode units and a cathode structure disposed concentrically within the anode structure. The cathode structure has a plurality of cathode units aligned with the respective anode units. The anode structure includes a transparent substrate such as a glass substrate. Each of the anode units comprises a conductive layer and a phosphor layer formed on the transparent substrate. The cathode structure includes a cathode substrate, and each of the cathode units further comprises a conductive layer and an electron emission layer formed on the cathode substrate. The electron emission layers are fabricated from carbon nanotube.

### BRIEF DESCRIPTION OF ACCOMPANIED DRAWINGS

The above objects and advantages of the present invention will be become more apparent by describing in detail exemplary embodiments thereof with reference to the attached drawings in which:

FIG. 1 shows a conventional dual-side field-emission display;

FIG. 2 shows the substrate used for forming the cathode structure of a multi-directional field-emission display;

FIG. 3 shows a first conductive layer formd on the peripheral sides of the substrate as shown in FIG. 3;

FIG. 4 shows a second conductive layer formed on the first conductive layer as shown in FIG. 3; and

FIG. 5 shows the assembly of the cathode structure and an anode structure in which the cathode structure is installed.

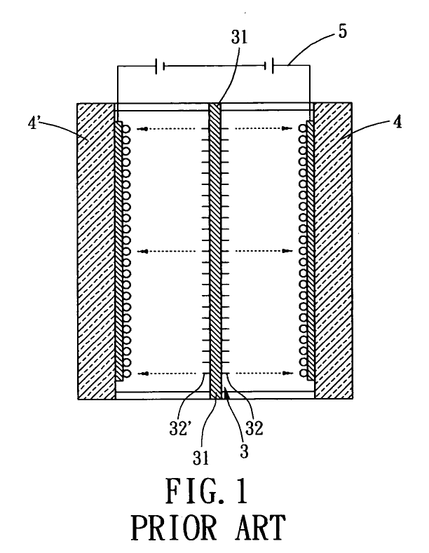

### DETAILED DESCRIPTION OF EMBODIMENT

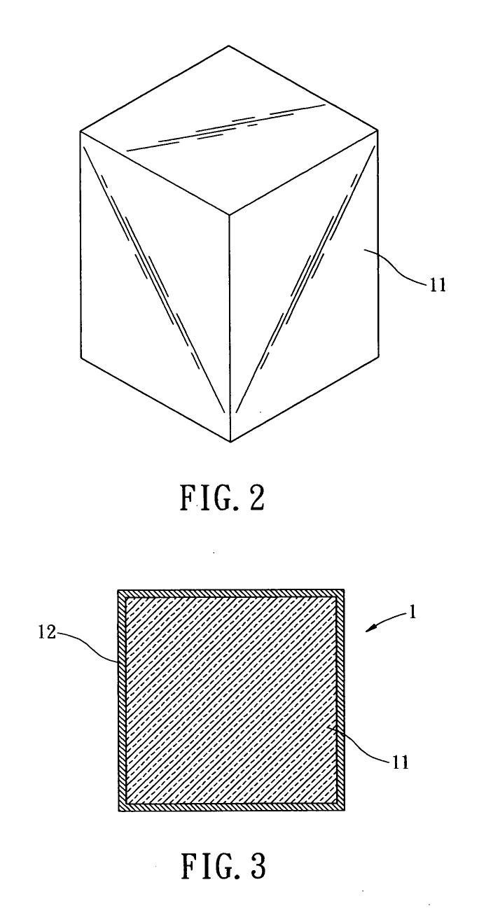

FIGS. 2 to 4 illustrate the structure and fabrication process of a multi-directional field-emission display which includes conductive layers and multi-directional electron cathode structure.

To fabricate the multi-directional cathode structure 1, a multiple-side substrate 11 made of glass material is provided.

A first conductive layer 12 is formed on the substrate 11. Preferably, the substrate 11 is fabricated from conductive material such as silver paste by sputter, spray or evaporation, for example.

After the first conductive layer 12 is formed, a second conductive layer 13 is formed on the first conductive layer 12 to serve as a cathode layer. The second conductive layer 13 uses carbon nanotube as the material. Electrophoresis can be used to form the second conductive layer 13 by spray coating or dipping the carbon nanotube material on the first conductive layer 12.

When the second conductive layer 13 is formed, a vacuum sintering process is performed to adhere the second conductive layer 13 on the first conductive layer 12, which is operative to generate multi-directional electron beam.

The above cathode structure 1 includes a multiple-side substrate 11 and the first and second conductive layers 12 and 13 formed on multiple sides of the substrate 11. Therefore, when an adequate voltage is applied to the cathode structure 1, electron beams are generated to propagate from all peripheral sides of the substrate 11 towards the anode structure 2, which will be described in detailed in the following paragraphs. As the peripheral sides of the substrate 1 (the cathode structure 1) are oriented with various angles, the electron beams generated from the cathode structure 1 propagate radially from the substrate 11.

Referring to FIG. 5, the package of the anode structure 2 and the multi-directional cathode structure 1 is illustrated. The multi-directional cathode structure 1 is disposed in the anode structure 2. The anode structure 2 includes a multiple-side hollow box. Preferably, the peripheral sides of the anode structure 2 matches the peripheral sides of cathode structure 1. That is, the cross section of the anode structure 1 preferably conforms to the cross section of the cathode structure 2. The anode structure 2 includes a shell substrate 21 formed of transparent glass material, on which a first conductive layer 22 is formed. The first conductive layer 22 can be formed from various materials such as silver paste. A second conductive layer 23 is formed on the first conductive layer 22. The second conductive layer 22 is preferably formed of single color phosphor powders or phosphor powders in red, green and blue or other combinations so as to produce full color image. The assembly of the anode structure 2 and the cathode 1 is then vacuumed to form the three-dimensional field-emission display.

When a control voltage is applied to the assembly, electron beams are generated from all peripheral sides of the cathode structure 1. The electron beams impinge on the second conductive layer 23 of the respective peripheral sides of the anode structure 2, such that light is generated from all peripheral sides of the anode structure 2 to produce the required image.

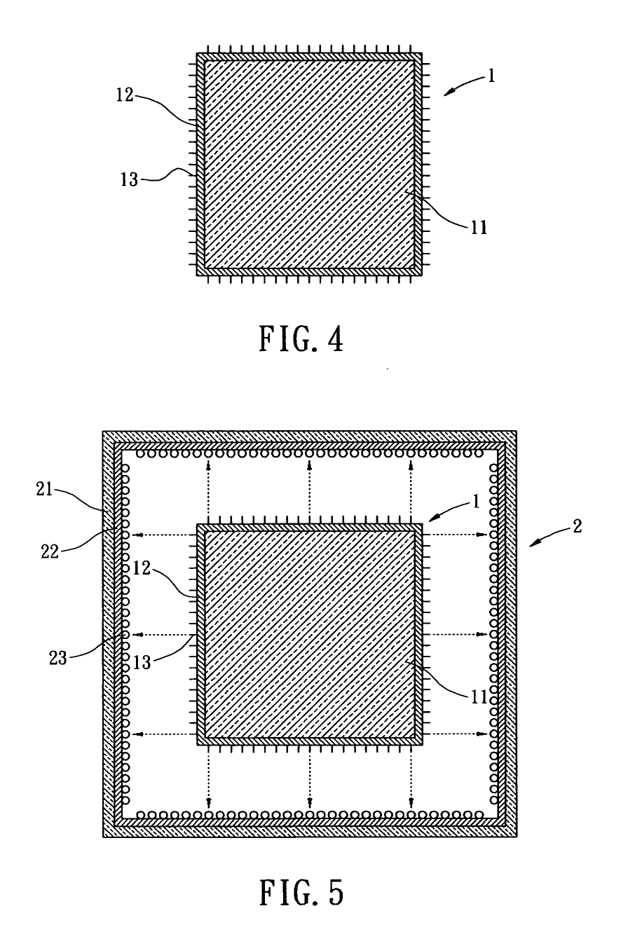

The field-emission display as shown in FIGS. 4 and 5 is configured into a rectangular prism. That is, both the cathode structure 1 and the anode structure 2 have rectangular cross sections. It will be appreciated that the field-emission display may also be configured into other geometries to achieve the three-dimensional display. For example, the cross sections of the cathode structure 1 and the anode structure 2 may be in the form of circles, polygons, triangle or other regular or irregular shapes without exceeding the spirit and scope of the present invention.

Further, in addition to the bipolar structure, tripolar or tetrapolar structure may also be fabricated in the same manner to obtain a more efficient multi-directional image. For example, a gate layer can be inserted between the cathode structure 1 and the anode structure 2 to form a tripolar field-emission display. A converging or focusing layer can be further installed between the gate layer and the anode structure 2 to obtain a tetrapolar display. The optional gate layer and the converging/focusing layer are preferably perforated with apertures aligned with each set of anode unit and cathode unit to provide unobstructed path for the electron beams.

Meanwhile, the heat generated by the cryogenic chip 5 is delivered upwardly through the heating face attached to the first heat sink 1 and the first heat sink 1. The heat is further guided out of the enclosure 20 through the venting holes 72 by the fan 3. Therefore, heat generated by the cryogenic chip 5 will not enter the host 200.

According to the above, the air-conditioning heat dissipation system 100 can efficiently reduces the temperature of the host, so as to enhance operation stability of thereof. As the heat source is disposed external to the host, and a heat dissipation mechanism is installed to effectively dissipate heat generated by the system, the heat dissipation performed is further improved.

The system 100 can also be inserted to the host from a rear panel as shown in FIG. 9.

While the present invention has been particularly shown and described with reference to preferred embodiments thereof, it will be understood by those of ordinary skill in the art the various changes in form and details may be made therein without departing from the spirit and scope of the present invention as defined by the appended claims.

1. A field emission display having multiple display directions, comprising:
an anode structure, having:
a shell substrate having a plurality of peripheral sides, each of the peripheral sides having an interior surface; and
a conductive layer and a phosphor layer formed on each interior surface of the shell substrate;
a cathode structure disposed within the shell substrate of the anode structure, the cathode structure having:
a plurality of peripheral sides facing respective interior surfaces of the anode structure;
a conductive layer and an electron emission layer formed on each peripheral side of the cathode structure.

2. The display as claimed in claim 1, wherein the shell substrate of the anode structure includes a transparent substrate.

3. The display as claimed in claim 1, wherein the shell substrate of the anode structure includes a glass substrate.

4. The display as claimed in claim 1, wherein the number of the peripheral sides of the anode structure matches the number of the peripheral sides of the cathode structure.

5. The display as claimed in claim 1, wherein the anode structure has a cross section conforming to that of the cathode structure.

6. The display as claimed in claim 1, wherein the cathode structure includes a glass substrate having configured with the peripheral sides.

7. The display as claimed in claim 1, wherein the electron emission layer is fabricated from carbon nanotube.

8. The display as claimed in claim 1, wherein the anode and cathode structures are in the form of tetragonal prism.

9. The display as claimed in claim 1, wherein the phosphor layers are fabricated from monochromatic phosphor powder or phosphor powers in three primary colors.

10. The display as claimed in claim 1, wherein the anode and cathode structure are in the form of polygonal prism.

11. A method of fabricating a multi-directional field-emission display, comprising:
providing a hollow shell transparent substrate, the substrate having a plurality of interior side surfaces;
forming a conductive layer and a phosphor layer on each of the interior side surfaces;
providing a cathode substrate having a plurality side surfaces;
forming a conductive layer and an electron-emission layer on each of the side surfaces; and
disposing the cathode substrate in the transparent substrate and aligning each side surface of the cathode substrate with a perspective interior side surface of the transparent substrate.

12. The method as claimed in claim 11, wherein the step of forming the conductive layer on the transparent substrate includes spray sputtering, coating or evaporation.

13. The method as claimed in claim 11, wherein the conductive layer of the transparent substrate is fabricated from silver paste.

14. The method as claimed in claim 11, wherein the electron emission layer is fabricated from carbon nanotube material.

15. The method as claimed in claim 11, further comprising a step of vacuum packing the anode structure and the cathode structure.

16. A multi-directional field-emission display, comprising:
an anode structure having a plurality of anode units; and
a cathode structure disposed concentrically within the anode structure, the cathode structure having a plurality of cathode units aligned with the respective anode units.

17. The display as claimed in claim 16, wherein the anode structure includes a transparent substrate.

18. The display as claimed in claim 17, wherein each of the anode units comprises a conductive layer and a phosphor layer formed on the transparent substrate.

19. The display as claimed in claim 16, wherein the cathode structure includes a cathode substrate.

20. The display as claimed in claim 19, wherein each of the cathode units further comprises a conductive layer and an electron emission layer formed on the cathode substrate.

21. The display as claimed in claim 20, wherein the electron emission layers are fabricated from carbon nanotube.
